(19) United States
(12) Patent Application Publication
(10) Pub. No.: US 2026/0235402 A1
(43) Pub. Date: Aug. 13, 2026

(54) SURVEYING INSTRUMENT

(71) Applicant: TOPCON CORPORATION, Itabashi-ku, Tokyo-to (JP)

(72) Inventor: Taichi Yuasa, Tokyo-to (JP)

(21) Appl. No.: 19/154,538

(22) PCT Filed: Feb. 15, 2024
(86) PCT No.: PCT/JP2024/005279

§ 371 Date: Aug. 7, 2025

(30) Foreign Application Priority Data
Feb. 16, 2023 (JP) 2023-022095

(51) Int. Cl. G01C 15/00; G01C 3/02; G02B 1/11; G02B 5/04

(52) U.S. Cl. CPC G01C 15/006; G01C 3/02; G02B 1/11; G02B 5/04

(57) ABSTRACT

A surveying instrument comprises a distance measuring light projecting module (23) having a light emitter (28) which emits a distance measuring light (35) to an object, a distance measuring light receiving module (24) having a light receiver (39) which receives a reflected distance measuring light (47) from the object, and an arithmetic control module which controls the distance measuring light projecting module and calculates a distance to the object based on a light receiving result of the reflected distance measuring light with respect to the light receiver, wherein the distance measuring light receiving module has a light receiving prism (44) which causes the reflected distance measuring light to be internally reflected at least once in a same plane, and the light receiving prism is configured such that, on a surface on a side opposite to an incident surface of the reflected distance measuring light, a recess portion (63) recessed to the incident surface side is formed, and the light receiver is arranged in the recess portion.

### TECHNICAL FIELD

The present invention relates to a surveying instrument capable of acquiring three-dimensional coordinates of an object.

### BACKGROUND ART

The surveying instrument such as a laser scanner, a total station has an electronic distance meter which detects a distance to an object by a prism distance measurement using a prism having a retro-reflectivity as an object, non-prism distance measurement not using a reflection prism.

In the surveying instrument, in order to match an optical axis of a distance measuring light projected toward the object with the optical axis of a reflected distance measuring light reflected from the object, the optical axes of the distance measuring light and the reflected distance measuring light are deflected by a mirror and the like. Further, in order to reduce a size of an optical system of the surveying instrument, the optical axes of the distance measuring light and the reflected distance measurement light are deflected a plurality of number of times in some cases.

When the optical axes of the distance measuring light and the reflected distance measurement light are deflected a plurality of number of times, dispositions of a light emitting element and a light receiving element are changed depending on deflection directions. Therefore, depending on dispositions of the light emitting element or the light receiving element, there is such a concern that a size enlargement of an optical system of the surveying instrument is incurred.

### PRIOR ART REFERENCES

### Patent Document

### [Patent Document 1]

Japanese Patent Application Publication No. 2021-25993

### [Patent Document 2]

Japanese Patent Application Publication No. 2021-101155

### SUMMARY OF THE INVENTION

### Problem to be Solved by the Invention

It is an object of the present invention to provide a surveying instrument which promotes a size reduction of an optical system.

### Means for Solving the Problem

The present invention relates to a surveying instrument comprising a distance measuring light projecting module having a light emitter which emits a distance measuring light to an object, a distance measuring light receiving module having a light receiver which receives a reflected distance measuring light from the object, and an arithmetic control module which controls the distance measuring light projecting module and calculates a distance to the object based on a light receiving result of the reflected distance measuring light with respect to the light receiver, wherein the distance measuring light receiving module has a light receiving prism which causes the reflected distance measuring light to be internally reflected at least once in a same plane, the light receiving prism is configured such that, on a surface on a side opposite to an incident surface of the reflected distance measuring light, a recess portion recessed to the incident surface side is formed, and the light receiver is arranged in the recess portion.

Further, the present invention relates to the surveying instrument, wherein the light receiver is a light receiving fiber, and the light receiving fiber is configured to extend upward and bend toward the incident surface.

Further, the present invention relates to the surveying instrument, wherein an optical axis of the reflected distance measuring light received by the light receiving fiber is configured to become parallel or substantially parallel to a surface on a side opposite to an incident surface of the reflected distance measuring light.

Further, the present invention relates to the surveying instrument, wherein the light receiving prism is constituted by a first prism, a second prism joined to the first prism, and a third prism joined to the second prism, the recess portion is formed by the first prism and the second prism, and the reflected distance measuring light is configured to be reflected toward the recess portion by a separation surface formed on a joined surface between the second prism and the third prism.

Further, the present invention relates to the surveying instrument which further comprises a tracking light projecting module having a tracking light emitter which emits a tracking light coaxially with the distance measuring light to the object and a tracking light receiving module which receives a reflected tracking light from the object coaxially with the reflected distance measuring light, wherein the tracking light receiving module has a tracking light receiving element provided on a sensor substrate disposed on a transmission side of the separation surface, the light receiving prism is configured to separate the reflected distance measuring light and the reflected tracking light which are coaxially incident by the separation surface and cause the reflected tracking light to be received by the tracking light receiving element.

Further, the present invention relates to the surveying instrument, wherein a chamfering is applied to a corner part of the first prism, a chamfered portion is formed, and a reflection preventing paint is coated to the chamfered portion.

Further, the present invention relates to the surveying instrument, wherein a band pass filter having a same diameter or a substantially same diameter as that of a light flux of the reflected tracking light is provided on a projection surface of the reflected tracking light of the light receiving prism, and a reflection preventing paint is coated to spots other than the band pass filter of the projection surface.

Furthermore, the present invention relates to the surveying instrument, wherein the chamfered portion, the light receiver, and an end part on a side opposite to the incident surface of the sensor substrate are configured to be disposed on a substantially same plane.

### Effects of the Invention

According to the present invention, the surveying instrument comprises a distance measuring light projecting module having a light emitter which emits a distance measuring light to an object, a distance measuring light receiving module having a light receiver which receives a reflected distance measuring light from the object, and an arithmetic control module which controls the distance measuring light projecting module and calculates a distance to the object based on a light receiving result of the reflected distance measuring light with respect to the light receiver, wherein the distance measuring light receiving module has a light receiving prism which causes the reflected distance measuring light to be internally reflected at least once in a same plane, the light receiving prism is configured such that, on a surface on a side opposite to an incident surface of the reflected distance measuring light, a recess portion recessed to the incident surface side is formed, and the light receiver is arranged in the recess portion. As a result, it is possible to prevent protrusion of the light receiver from the light receiving prism to a surface side on the opposite side, and to promote size reduction of an optical system of the distance measuring light receiving module and size reduction of an entire instrument.

### BRIEF DESCRIPTION OF DRAWINGS

FIG. 1 is a front sectional diagram illustrating a surveying instrument according to a first embodiment.

FIG. 2A is a configuration diagram illustrating a distance measuring module according to the first embodiment, and FIG. 2B is a side view of a reflection prism.

FIG. 3A is a diagram for explaining a phase difference generated in a reflected tracking light, and FIG. 3B is an explanatory diagram illustrating a tracking image acquired in a state having the phase difference.

FIG. 4 is an extended drawing illustrating a light receiving prism according to the first embodiment.

FIG. 5 is a chart for explaining the phase difference generated in the reflected tracking light at a reflection or a transmission.

FIG. 6 is a configuration diagram illustrating the distance measuring module according to a second embodiment.

FIG. 7 is an extended drawing illustrating the light receiving prism according to the second embodiment.

### MODE(S) FOR CARRYING OUT THE INVENTION

A description will be given below on embodiments of the present invention by referring to the attached drawings.

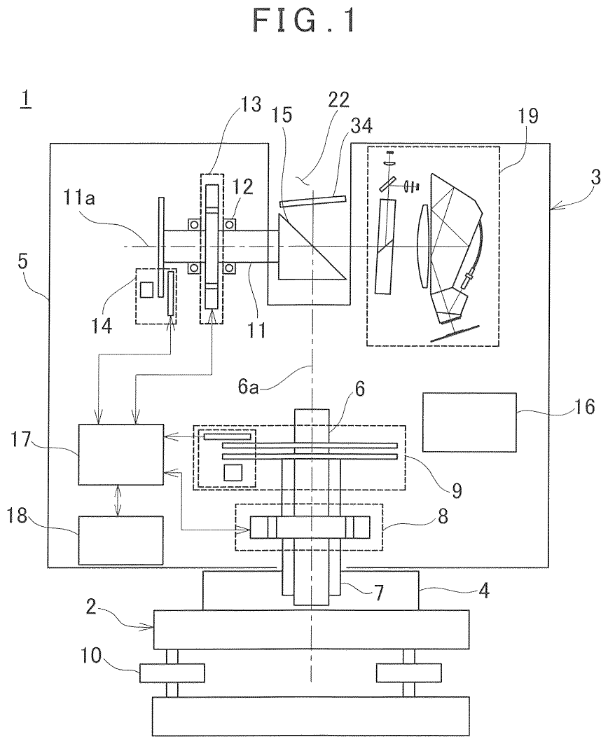

First, in FIG. 1, a description will be given on a surveying instrument according to a first embodiment of the present invention.

A surveying instrument 1 is a laser scanner, for instance, constituted by a leveling module 2 mounted on a tripod (not shown) and a surveying instrument main body 3 mounted on the leveling module 2.

The leveling module 2 has a leveling screw 10 and performs leveling of the surveying instrument main body 3 by the leveling screw 10.

The surveying instrument main body 3 includes a fixing unit 4, a frame unit 5, a horizontal rotation shaft 6, a horizontal rotation bearing 7, a horizontal rotation motor 8 as a horizontal rotation driver, a horizontal angle encoder 9 as a horizontal angle detector, a vertical rotation shaft 11, a vertical rotation bearing 12, a vertical rotation motor 13 as a vertical rotation driver, a vertical angle encoder 14 as a vertical angle detector, a scanning mirror 15 which is a vertical rotation unit, an operation panel 16 serving both as an operation module and a display module, an arithmetic control module 17, a storage module 18, a distance measuring module 19, etc. It is to be noted that, as the arithmetic control module 17, a CPU specialized for this instrument or a general-purpose CPU is used.

The horizontal rotation bearing 7 is fixed to the fixing unit 4. The horizontal rotation shaft 6 has a vertical axis 6a, and the horizontal rotation shaft 6 is rotatably supported by the horizontal rotation bearing 7. Further, the frame unit 5 is supported by the horizontal rotation shaft 6, and the frame unit 5 is configured to be rotated in the horizontal direction integrally with the horizontal rotation shaft 6.

Between the horizontal rotation bearing 7 and the frame unit 5, the horizontal rotation motor 8 is provided, and the horizontal rotation motor 8 is controlled by the arithmetic control module 17. The arithmetic control module 17 causes the frame unit 5 to be rotated around the axis 6a by the horizontal rotation motor 8.

A relative rotation angle of the frame unit 5 with respect to the fixing unit 4 is detected by the horizontal angle encoder 9. A detection signal from the horizontal angle encoder 9 is input into the arithmetic control module 17, and a horizontal angle data is calculated by the arithmetic control module 17. Based on the horizontal angle data, the arithmetic control module 17 performs a feedback control with respect to the horizontal rotation motor 8.

Further, in the frame unit 5, the vertical rotation shaft 11 having a horizontal axis 11a is provided. The vertical rotation shaft 11 is rotatable via the vertical rotation bearing 12. It is to be noted that an intersection of the axis 6a and the axis 11a is a projection position of a distance measuring light and is an origin of a coordinate system of the surveying instrument main body 3.

In the frame unit 5, a recess portion 22 is formed. One end part of the vertical rotation shaft 11 extends into the recess portion 22, the scanning mirror 15 is fixed to the one end part, and the scanning mirror 15 is accommodated in the recess portion 22. Further, at the other end part of the vertical rotation shaft 11, the vertical angle encoder 14 is provided.

The vertical rotation motor 13 is provided on the vertical rotation shaft 11, and the vertical rotation motor 13 is controlled by the arithmetic control module 17. The arithmetic control module 17 rotates the vertical rotation shaft 11 by the vertical rotation motor 13, and the scanning mirror 15 is rotated around the axis 11a.

A rotation angle of the scanning mirror 15 is detected by the vertical angle encoder 14, and a detection signal is input into the arithmetic control module 17. The arithmetic control module 17 calculates a vertical angle data of the scanning mirror 15 based on the detection signal, and performs feedback control with respect to the vertical rotation motor 13 based on the vertical angle data.

Further, the horizontal angle data and the vertical angle data calculated by the arithmetic control module 17, and measurement results are stored in the storage module 18. As the storage module 18, various types of storage devices such as an HDD as a magnetic recording device, a CD and a DVD as an optical storage device, a memory card and a USB memory as a semiconductor storage device are used. The storage module 18 may be attached to or detached from the frame unit 5 or may be capable of transmitting a data to an external storage device and an external data processing device via a communication means, not shown.

In the storage module 18, various types of programs such as a sequence program for controlling a distance measuring operation, a calculation program for calculating a distance by a distance measuring operation, a calculation program for calculating an angle based on the horizontal angle data and the vertical angle data, a program for calculating three-dimensional coordinates of a desired measuring point based on the distance and the angle, are stored. Further, when the various types of programs are executed by the arithmetic control module 17, the various types of processing are executed.

The operation panel 16 is a touch panel, for instance, and serves both as an operation module which performs changes and the like of an instruction of a distance measurement and measurement conditions such as a measuring point interval, for instance, and a display module which displays distance measurement results, images, etc.

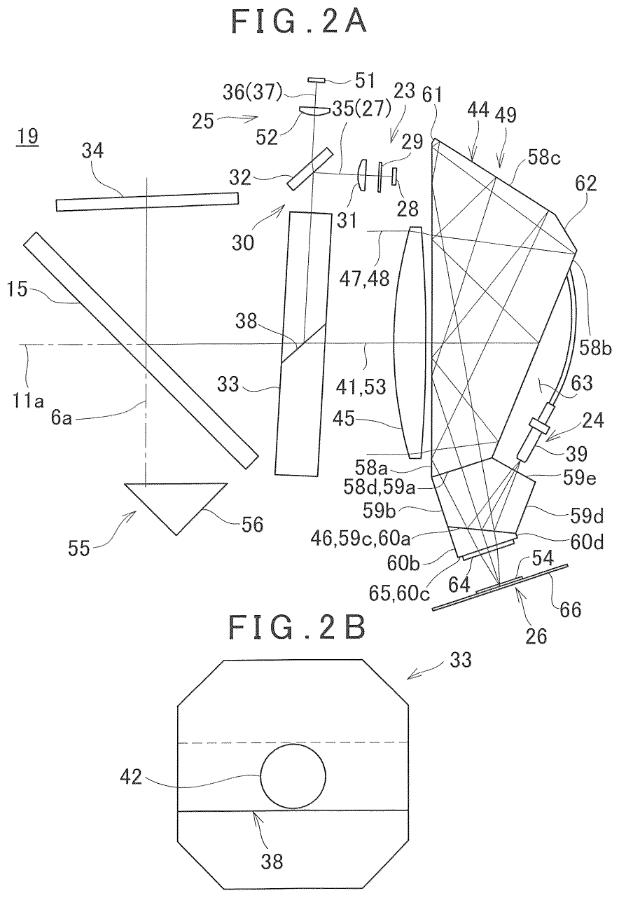

Next, a description will be given on the distance measuring module 19 by referring to FIG. 2A.

The distance measuring module 19 has a distance measuring light projecting module 23, a distance measuring light receiving module 24, a tracking light projecting module 25, and a tracking light receiving module 26. It is to be noted that a distance measuring module is constituted by the distance measuring light projecting module 23 and the distance measuring light receiving module 24, and a tracking module is constituted by the tracking light projecting module 25 and the tracking light receiving module 26.

The distance measuring light projecting module 23 has a distance measuring optical axis 27. Further, the distance measuring light projecting module 23 has a light emitter 28 such as a laser diode (LD), a plane-parallel plate 29, a collimator lens 31, and a dichroic mirror 32 provided on the distance measuring optical axis 27, in order from a light emitting side. Further, a reflection prism 33 as a deflection optical member is provided on a reflection optical axis of the dichroic mirror 32, and the scanning mirror 15 is provided on the reflection optical axis of the reflection prism 33. Further, a window portion 34 formed by a transparent material and rotating integrally with the scanning mirror 15 is provided on the reflection optical axis of the scanning mirror 15.

It is to be noted that the plane-parallel plate 29, the collimator lens 31, the dichroic mirror 32, and the reflection prism 33 constitute a light projecting optical system 30. Further, in the present embodiment, the distance measuring optical axis 27, the distance measuring optical axis 27 reflected by the dichroic mirror 32, the distance measuring optical axis 27 reflected by the reflection prism 33, and the distance measuring optical axis 27 reflected by the scanning mirror 15 are collectively called the distance measuring optical axis 27.

The plane-parallel plate 29 is a glass plate having a predetermined plate thickness, for instance, and is arranged such that an incident surface and a projection surface become orthogonal to the distance measuring optical axis 27. Further, the plane-parallel plate 29 is insertable and removable with respect to the distance measuring optical axis 27 by a drive mechanism such as a solenoid, not shown, and the plane-parallel plate 29 is inserted/removed as appropriate in accordance with an object. That is, it is configured such that, when a prism measurement, in which an object is a prism or the like having a retro-reflectivity, is to be performed, the plane-parallel plate 29 is inserted on the distance measuring optical axis 27, when a non-prism measurement, in which the object is those other than the prism, is to be performed, the plane-parallel plate 29 is removed from on the distance measuring optical axis 27.

By inserting the plane-parallel plate 29 onto the distance measuring optical axis 27, it is configured such that a spread angle of a distance measuring light 35 with an infrared wavelength or a near-infrared wavelength emitted from the light emitter 28 enlarges via the plane-parallel plate 29. The spread angle φ enlarged by the plane-parallel plate 29 is set as appropriate in 2 to 20 minutes. In the present embodiment, the spread angle φ of the distance measuring light 35 by the plane-parallel plate 29 is 6 minutes.

In a state where the plane-parallel plate 29 is not inserted on the distance measuring optical axis 27, the collimator lens 31 makes the distance measuring light 35 into a parallel light flux. Further, in a state where the plane-parallel plate 29 is inserted on the distance measuring optical axis 27, the collimator lens 31 causes the distance measuring light 35 to be slightly diverged.

The dichroic mirror 32 has an optical characteristic which reflects the distance measuring light 35 and transmits a tracking light 36 (to be described later). Further, the dichroic mirror 32 is provided on a common optical path of the distance measuring light 35 and the tracking light 36 (an intersection position of the distance measuring optical axis 27 and a tracking optical axis 37 (to be described later)) and deflects (reflects) the distance measuring optical axis 27 such that the distance measuring optical axis 27 matches the tracking optical axis 37. Therefore, the distance measuring light 35 and the tracking light 36 are emitted coaxially toward an object.

The reflection prism 33 is formed by joining two trapezoidal prisms. In a state where the two prisms are joined, the reflection prism 33 has a rectangular shape. An incident surface of the reflection prism 33 into which the distance measuring light 35 is incident is orthogonal to the distance measuring optical axis 27, and a joined surface 38 of the reflection prism 33 is tilted by a predetermined angle with respect to the distance measuring optical axis 27. Further, a projection surface of the reflection prism 33 to which the distance measuring light 35 is projected (transmitted) is configured such that the distance measuring optical axis 27 reflected by the joined surface 38 is incident with a slight tilt such as 2.5°, for instance. Therefore, the distance measuring light 35 internally reflected by the projection surface of the reflection prism 33 is prevented from being received by a light receiving fiber (optical fiber) 39 as a light receiver. It is to be noted that a tilt angle of the joined surface 38 is an angle which deflects (reflects) the distance measuring optical axis 27 such that the distance measuring optical axis 27 matches a light receiving optical axis 41 (to be described later) and the axis 11a. Further, the light receiver may be an Avalanche Photo Diode (APD) or an equivalent photoelectric conversion element.

As shown in FIG. 2B, a beam splitter film 42 is formed at a center part of the joined surface 38. The beam splitter film 42 has an elliptic shape in accordance with a light flux of the distance measuring light 35. Further, a size of the beam splitter film 42 is equivalent to a light flux diameter of the distance measuring light 35 diverged by the plane-parallel plate 29 or slightly larger than the light flux. Further, the beam splitter film 42 has an optical characteristic of reflecting 80% of a light and transmitting 20% of the light, for instance.

It is to be noted that a ratio between a reflectance and a transmittance in the beam splitter film 42 is set as appropriate in accordance with a purpose and a distance to an object. For instance, when a distance to the object is short, the beam splitter film 42 is preferably selected from ranges of the reflectance at 50 to 70% and the transmittance at 30 to 50, for instance. Further, when a distance to the object is long, the beam splitter film 42 is preferably selected from ranges of the reflectance at 70 to 90% and the transmittance at 10 to 30%, for instance.

The distance measuring light receiving module 24 has the light receiving optical axis 41. Further, the distance measuring light receiving module 24 has, in order from a light receiving side, a light receiving fiber 39 as the light receiver and a light receiving prism 44 provided on the light receiving optical axis 41 and also has a light receiving lens 45 having a predetermined NA (Numerical Aperture) provided on the light receiving optical axis 41 reflected by the light receiving prism 44.

The light receiving prism 44 has a dichroic film 46 (to be described later) as a separation surface. The light receiving prism 44 is configured such that the distance measuring light 35 (reflected distance measuring light 47) reflected by the object and the tracking light 36 (reflected tracking light 48) incident coaxially with the reflected distance measuring light 47 are reflected at least once on the same plane. Further, the dichroic film 46 has an optical characteristic that reflects the reflected distance measuring light 47 and transmits the reflected tracking light 48.

It is to be noted that, a light receiving optical system 49 is constituted by the light receiving prism 44, the light receiving lens 45, and the reflection prism 33. Further, in the present embodiment, the light receiving optical axis 41 and the light receiving optical axis 41 reflected by the light receiving prism 44, the dichroic film 46 and the scanning mirror 15 are collectively called the light receiving optical axis 41.

The tracking light projecting module 25 has the tracking optical axis 37. Further, the tracking light projecting module 25 has a tracking light emitter 51, a collimator lens 52, and the dichroic mirror 32 provided on the tracking optical axis 37 and also has the reflection prism 33 provided on a reflection optical axis of the dichroic mirror 32 in order from a light emission side.

It is to be noted that, in the present embodiment, the tracking optical axis 37 and the tracking optical axis 37 reflected by the reflection prism 33 and the scanning mirror 15 are collectively called the tracking optical axis 37. Further, the light emitter 28 emitting the distance measuring light 35 is provided on a reflection side of the dichroic mirror 32, and the tracking light emitter 51 emitting the tracking light 36 is provided on a transmission side of the dichroic mirror 32. On the other hand, the tracking light emitter 51 may be provided on a reflection side of the dichroic mirror 32, and the light emitter 28 may be provided on a transmission side of the dichroic mirror 32.

The tracking light emitter 51 is a laser diode (LD), for instance, and is configured to emit the tracking light 36 with a near-infrared wavelength different from a wavelength of the distance measuring light 35. Further, the collimator lens 52 is configured to make the tracking light 36 emitted from the tracking light emitter 51 into a parallel light flux.

The tracking light receiving module 26 has a tracking light receiving optical axis 53. Further, the tracking light receiving module 26 has, in order from a light receiving side, a tracking light receiving element 54, a band pass filter 64, the light receiving prism 44 provided on the tracking light receiving optical axis 53, and the light receiving lens 45 provided on a reflection optical axis of the light receiving prism 44.

It is to be noted that, in the present embodiment, the tracking light receiving optical axis 53 and the tracking light receiving optical axis 53 reflected by the light receiving prism 44 and the scanning mirror 15 are collectively called the tracking light receiving optical axis 53.

The tracking light receiving element 54 is a CCD or a CMOS sensor, which is an aggregation of pixels, and each pixel is configured such that it is possible to specify a position on the tracking light receiving element 54. For instance, each pixel has a pixel coordinate with a center of the tracking light receiving element 54 as an origin, and the position on the tracking light receiving element 54 is specified by the pixel coordinate.

The distance measuring module 19 is controlled by the arithmetic control module 17. When the pulse-state distance measuring light 35 is projected from the light emitter 28 onto the distance measuring optical axis 27, the distance measuring light 35 is incident into the collimator lens 31. Further, when the plane-parallel plate 29 is present on the distance measuring optical axis 27, the distance measuring light 35 is incident into the collimator lens 31 while a spread angle is slightly widened via the plane-parallel plate 29.

When the distance measuring light 35 is incident into the collimator lens 31 directly from the light emitter 28, the collimator lens 31 makes the distance measuring light 35 into a parallel light flux. Further, when the distance measuring light 35 is incident into the collimator lens 31 via the plane-parallel plate 29, the collimator lens 31 causes the distance measuring light 35 to be slightly diverged.

The distance measuring light 35 transmitted through the collimator lens 31 is incident at a right angle with respect to an incident surface of the reflection prism 33, is transmitted through an inside of the reflection prism 33, is reflected by the joined surface 38 (beam splitter film 42) so as to become coaxial with the light receiving optical axis 41 and the axis 11a. The distance measuring light 35 projected from a projection surface of the reflection prism 33 is deflected at a right angle by the scanning mirror 15 and is made to irradiate an object via the window portion 34. By rotating the scanning mirror 15 around the axis 11a, the distance measuring light 35 becomes orthogonal to the axis 11a and is rotated (scanned) in a plane including the axis 6a.

It is to be noted that the window portion 34 is provided by being tilted by a predetermined angle with respect to an optical axis of the distance measuring optical axis 27 such that the distance measuring light 35 reflected by the window portion 34 is not incident into the light receiving fiber 39.

The reflected distance measuring light 47 reflected by an object is reflected at a right angle by the scanning mirror 15, goes through the light receiving optical system 49, and is received by the light receiving fiber 39.

The arithmetic control module 17 performs a distance measurement per pulse of the distance measuring light 35 (Time of Flight) based on a time difference between a light emitting timing of the light emitter 28 and a light receiving timing of the light receiving fiber 39 (that is, a reciprocating time of a pulsed light) and a light speed, and calculates a distance to the object. It is to be noted that it is possible to change the light emitting timing of the light emitter 28, that is, a pulse interval, via the operation panel 16. Further, based on a horizontal angle data and a vertical angle data acquired by the distance measurement result, the horizontal angle encoder 9, and the vertical angle encoder 14, it is possible to calculate a three-dimensional coordinate of the object.

Further, while the distance measuring light 35 is projected at a predetermined pulse interval, and by rotating the frame unit 5 and the scanning mirror 15, respectively, at a constant speed, the distance measuring light 35 is scanned two-dimensionally in the cooperation between a rotation in a vertical direction of the scanning mirror 15 and a rotation in a horizontal direction of the frame unit 5. Further, by detecting a vertical angle and a horizontal angle by the vertical angle encoder 14 and the horizontal angle encoder 9 at each pulsed light, it is possible to acquire a vertical angle data and a horizontal angle data. By using the vertical angle data, the horizontal angle data, the distance measurement data, it is possible to acquire a three-dimensional coordinate of an object and a three-dimensional point cloud data corresponding to the object with an installation position of the surveying instrument 1 as a reference.

It is to be noted that, an internal reference light optical system 55 is provided in the distance measuring module 19. The internal reference light optical system 55 has a reference prism 56 provided below the scanning mirror 15, and an optical path length from the light emitter 28 to the reference prism 56 and an optical path length from the reference prism 56 to a light receiving surface of the light receiving fiber 39 are known. Therefore, by determining the distance measuring light 35 reflected by the reference prism 56 as an internal reference light and by performing the distance measurement based on a time difference of the light receiving timings of the internal reference light and the reflected distance measuring light 47, and light speeds, more accurate distance measurement is made possible.

Further, in parallel with the distance measuring operation, when the tracking light 36 with a wavelength different from the distance measuring light 35 is projected from the tracking light emitter 51, after the tracking light 36 is made into a parallel light flux by the collimator lens 52, it is deflected by the dichroic mirror 32 and becomes coaxial with the distance measuring light 35.

The reflected tracking light 48 made to irradiate the object coaxially with the distance measuring light 35 and reflected by the object is separated from the reflected distance measuring light 47 by the dichroic film 46 in a process of passing through the light receiving optical system 49 and is received by the tracking light receiving element 54.

The arithmetic control module 17 is configured to calculate a position deviation between a center of the tracking light receiving element 54 and a light receiving position (center of a tracking image) of the reflected tracking light 48 with respect to the tracking light receiving element 54, to drive the horizontal rotation motor 8 and the vertical rotation motor 13 such that the center and the light receiving position match each other based on the position deviation, and to track an object.

Next, a description will be given on the detail of the light receiving optical system 49. The light receiving prism 44 is constituted by a first prism 58, a second prism 59, and a third prism 60. It is to be noted that, in the following explanation, in FIG. 2A, the explanation will be made, with an upper side with respect to a paper surface as up, a lower side with respect to the paper surface as down, a right side with respect to the paper surface as right, a left side with respect to the paper surface as left, a depth side with respect to the paper surface as depth, and a front side with respect to the paper surface as front.

The first prism 58 has a predetermined refractive index and is a polygonal prism having four reflection surfaces, that is, a first surface 58a, a second surface 58b, a third surface 58c, and a fourth surface 58d. The first surface 58a is an incident surface of the reflected distance measuring light 47 and the reflected tracking light 48 and is configured to become orthogonal to the light receiving optical axis 41 and the tracking light receiving optical axis 53 incident into the first prism 58. Further, on the whole surface of the first surface 58a, a reflection preventing film (AR coat) is provided.

The second surface 58b opposes the first surface 58a and has an area smaller than that of the first surface 58a, an upper end of the second surface 58b is located on a lower side of an upper end of the first surface 58a, and a lower end of the second surface 58b is located on an upper side of a lower end of the first surface 58a. Further, the second surface 58b is configured to be tilted by a predetermined angle such that the second surface 58b is separated from the first surface 58a from below to above. Further, the second surface 58b is a mirror to which a mirror finishing is applied, for instance.

The third surface 58c is formed between an upper end of the first surface 58a and an upper end of the second surface 58b and is configured such that the third surface 58c is tilted downward by a predetermined angle from the first surface 58a toward the second surface 58b. Further, the fourth surface 58d is formed between a lower end of the first surface 58a and a lower end of the second surface 58b by opposing the third surface 58c and is configured such that the fourth surface 58d is tilted upward by a predetermined angle from the first surface 58a toward the second surface 58b. Further, the third surface 58c is a mirror to which a mirror finishing is applied, for instance.

A corner part formed by the first surface 58a and the third surface 58c is chamfered, and a first chamfered portion 61 is formed. Further, a corner part formed by the second surface 58b and the third surface 58c is chamfered, and a second chamfered portion 62 is formed. It is to be noted that the first chamfered portion 61 and the second chamfered portion 62 are formed outside an optical path of the reflected distance measuring light 47 which internally reflects an inside of the first prism 58. Further, a reflection preventing paint is coated to the first chamfered portion 61 and the second chamfered portion 62.

The second prism 59 has a predetermined refractive index and is a pentagonal prism having five surfaces, that is, a first surface 59a, a second surface 59b, a third surface 59c, a fourth surface 59d, and a fifth surface 59e. The first surface 59a is an incident surface into which the reflected distance measuring light 47 reflected in the first prism 58 is incident at an incident angle of 0°, has the same area as that of the fourth surface 58d, and is joined to the fourth surface 58d. That is, the fourth surface 58d and the first surface 59a are joined surfaces which join the first prism 58 and the second prism 59 to each other.

The second surface 59b extends in a direction separated from the first prism 58 from a left end of the first surface 59a. Further, an angle formed by the first surface 59a and the second surface 59b is a right angle, for instance.

The third surface 59c extends from a lower end of the second surface 59b toward a right side such that the third surface 59c opposes the first surface 59a. Further, an angle formed by the second surface 59b and the third surface 59c is an obtuse angle, for instance.

The fourth surface 59d extends from a right end of the third surface 59c in a direction approaching the first prism 58, and the fifth surface 59e is formed between an upper end of the fourth surface 59d and a right end of the first surface 59a. Further, an angle formed by the first surface 59a and the fifth surface 59e is an obtuse angle.

Since the fourth surface 58d and the first surface 59a are surfaces of the same area and are joined, the second surface 58b of the first prism 58 and the fifth surface 59e of the second prism 59 continue to each other. Further, the second surface 58b is tilted in a direction separated from an incident surface (the first surface 58a) of the reflected distance measuring light 47 and the reflected tracking light 48 upward from below with a joined surface as a starting point, and the fifth surface 59e is tilted in a direction separated from the first surface 58a upward with a joined surface as a starting point. Therefore, by means of the second surface 58b and the fifth surface 59e, a recess portion 63 recessed toward the first surface 58a is formed. That is, the recess portion 63 is formed in a surface on a side opposite to the incident surface of the reflected distance measuring light 47 and the reflected tracking light 48 of the light receiving prism 44.

The third prism 60 has a predetermined refractive index and is a quadrangle prism having four surfaces, that is, a first surface 60a, a second surface 60b, a third surface 60c, and a fourth surface 60d. The first surface 60a is an incident surface of the reflected distance measuring light 47 and the reflected tracking light 48 transmitted through an inside of the second prism 59, has the same area as that of the third surface 59c, and is joined to the third surface 59c. That is, the third surface 59c and the first surface 60a are joined surfaces for joining the second prism 59 and the third prism 60. Further, on the joined surface between the second prism 59 and the third prism 60, the dichroic film 46 which reflects the reflected distance measuring light 47 and transmits the reflected tracking light 48 is provided.

The second surface 60b extends in a direction separated from the second prism 59 from a left end of the first surface 60a. Further, the second surface 59b and the second surface 60b continue to each other and become flush.

The third surface 60c extends in a direction separated from an incident surface (the first surface 58a) of the reflected distance measuring light 47 and the reflected tracking light 48 from a lower end of the second surface 60b. Further, an angle formed by the second surface 60b and the third surface 60c is a right angle, for instance, and the third surface 60c is parallel to the fourth surface 58d of the first prism 58 and the first surface 59a of the second prism 59. Further, the fourth surface 60d is formed between a right end of the third surface 60c and a right end of the first surface 60a.

Further, at a center of the third surface 60c, a band pass filter 64 with a predetermined size is provided, and in a periphery of the band pass filter 64, a reflection preventing paint 65 is coated. The size of the band pass filter 64 is equal to or slightly larger than a light flux diameter of the reflected tracking light 48 transmitted through the dichroic film 46. By means of the band pass filter 64, it is possible to remove a light with a wavelength different from a wavelength of the tracking light 36 from the reflected tracking light 48.

At a light collecting position of the reflected distance measuring light 47 opposing the fifth surface 59e and reflected by the dichroic film 46, a light receiving surface of the light receiving fiber 39 is provided. The light receiving surface of the light receiving fiber 39 is located in the recess portion 63, and the light receiving fiber 39 passes on a depth side of the light receiving prism 44 and is bent toward an incident surface side of the light receiving prism 44.

It is to be noted that the light receiving optical axis 41 of the reflected distance measuring light 47 reflected by the dichroic film 46 is parallel or substantially parallel to the second surface 58b of the first prism 58. Since the light receiving optical axis 41 and the second surface 58b become parallel or substantially parallel to each other, the most protruding part (a part protruding only by a bending radius of the light receiving fiber 39) is located above the light receiving prism 44, and it is possible to prevent the light receiving fiber 39 which was bent from protruding from the recess portion 63 in a direction separated from the second surface 58b of the first prism 58. That is, it is possible to prevent the light receiving optical system 49 from being enlarged in a direction of the light receiving optical axis 41. Further, it is possible to prevent the light receiving fiber 39 from approaching the second surface 58b and from being bent.

At a light collecting position of the reflected tracking light 48 opposing the third surface 60c and transmitted through the dichroic film 46, the tracking light receiving element 54 is provided. Further, the tracking light receiving element 54 is provided on a sensor substrate 66.

It is to be noted that a right end (lower end) of the second chamfered portion 62, a right end of the light receiving fiber 39 bent toward an incident surface of the light receiving prism 44, and a right end of the sensor substrate 66 are located on substantially the same plane.

The reflected distance measuring light 47 and the reflected tracking light 48 transmitted through the light receiving lens 45 are incident coaxially at a right angle with respect to the first surface 58a of the first prism 58. The reflected distance measuring light 47 and the reflected tracking light 48 having been incident into the first prism 58 are reflected sequentially on the same plane by the second surface 58b, the first surface 58a, the third surface 58c, and the first surface 58a and are incident at a right angle with respect to the fourth surface 58d (the first surface 59a). It is to be noted that the reflected distance measuring light 47 and the reflected tracking light 48 reflected by the third surface 58c intersect the reflected distance measuring light 47 and the reflected tracking light 48 transmitted through the first surface 58a and the reflected distance measuring light 47 and the reflected tracking light 48 reflected by the second surface 58b.

The reflected distance measuring light 47 and the reflected tracking light 48 having been incident into the second prism 59 are incident into the third surface 59c (the first surface 60a), that is, the dichroic film 46 as a separation surface, and are separated into the reflected distance measuring light 47 and the reflected tracking light 48.

The reflected distance measuring light 47 is reflected by the dichroic film 46, is incident at a right angle into the fifth surface 59e, and is received by the light receiving fiber 39. Further, the reflected tracking light 48 has, in a process of being transmitted through the dichroic film 46, incident at a right angle into the third surface 60c, and passing through the band pass filter 64, a light with a wavelength different from a wavelength of the tracking light 36 removed and is received by the tracking light receiving element 54.

It is to be noted that a stray light which passes outside optical paths of the reflected distance measuring light 47 and the reflected tracking light 48 such as the distance measuring light 35 and the tracking light 36 reflected by the window portion 34 is absorbed by the first chamfered portion 61, the second chamfered portion 62 or the reflection preventing paint 65 and is shut off. Therefore, the light reception of the stray light with respect to the light receiving fiber 39 and the tracking light receiving element 54 is prevented.

Here, a light such as the reflected distance measuring light 47 or the reflected tracking light 48 generates, when it is transmitted or reflected with respect to the prism or the like, a phase difference (transmission phase, reflection phase) in correspondence with an incident angle with respect to a transmission surface and a reflection surface.

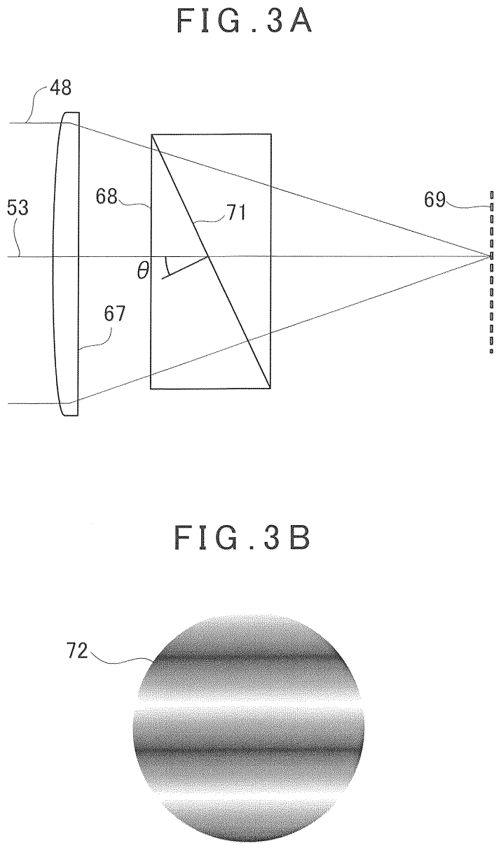

FIG. 3A and FIG. 3B are simple explanatory diagrams for explaining the phase differences described above. In FIG. 3A, a reference numeral 67 denotes a light receiving lens, 68 denotes a rectangular prism, 69 denotes a two-dimensional photodetection sensor, and 71 denotes a dichroic film provided on the prism 68.

For instance, when the reflected tracking light 48 is incident into the light receiving lens 45, the reflected tracking light 48 is transmitted through the prism 68 and the dichroic film 71, while it is collected, and is received by the photodetection sensor 69.

At this time, the reflected tracking light 48 incident into the dichroic film 71 is not a parallel light flux, and the dichroic film 71 is not at right angle with respect to the tracking light receiving optical axis 53. Therefore, the reflected tracking light 48 has a different incident angle θ with respect to the dichroic film 71 depending on an in-plane position of the light flux. Therefore, the reflected tracking light 48 transmitted through the dichroic film 71 generates a phase difference at each in-plane position and as shown in FIG. 3B, a tracking image 72 having an interference fringe is formed on the photodetection sensor 69.

Usually, a center of the tracking image 72 is calculated by a center-of-gravity calculation or a center-of-drawing calculation. However, when the tracking image 72 has an interference fringe, a calculation accuracy lowers, and a position accuracy of a center also lowers and thus, a tracking accuracy lowers. It is possible to correct an influence of an interference fringe by an image processing, but it is difficult to completely correct an error of a position accuracy by an interference fringe with an image processing. Further, it is also possible to measure an interference fringe per individual machine for a correction of an interference fringe and to calibrate an individual difference of a pattern of an interference fringe generated by a variation at a manufacture of a dichroic film of a prism, but an assembling cost increases.

Thus, in the present embodiment, an incident angle of the light receiving prism 44 with respect to a transmission surface and a reflection surface and a phase setting of a film are adjusted, and a reduction of a phase difference generated in the reflected tracking light 48 is promoted.

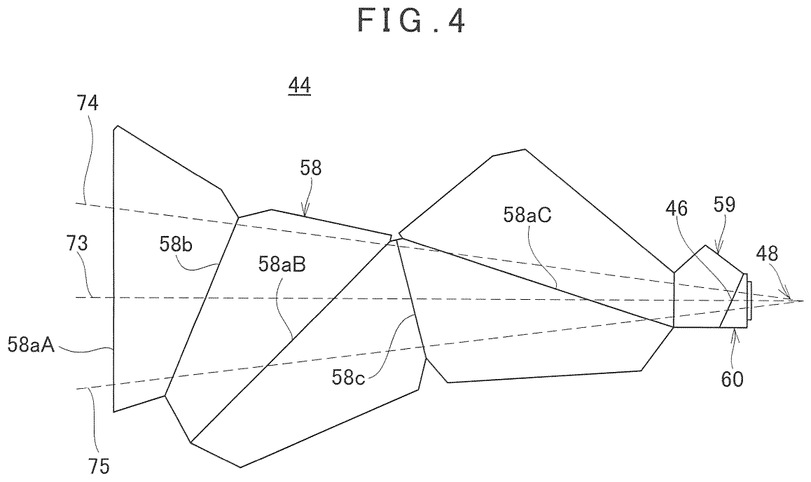

FIG. 4 illustrates an extended drawing of the light receiving prism 44. It is to be noted that, in FIG. 4, in the reflected tracking light 48, a light beam having an incident angle of 0° (orthogonal) with respect to the first surface 58a is a chief ray 73. Further, in the reflected tracking light 48, a light beam on an uppermost side with respect to a paper surface in FIG. 4 is assumed to be a Y+ light beam 74, and a light beam on a lowermost side with respect to the paper surface in FIG. 4 to be a Y− light beam 75. That is, the Y+ light beam 74 and the Y− light beam 75 are light beams with the largest phase difference with respect to the chief ray 73 in the reflected tracking light 48.

Further, in FIG. 4, the first surface 58aA, which is an incident surface of the chief ray 73 is a plane orthogonal with respect to an optical axis of the chief ray 73. Further, the second surface 58b, which is a reflection surface at a first time, the first surface 58aB, which is a reflection surface at a second time, the dichroic film 46 (the fourth surface 58d, the first surface 59a), which is a transmission surface, have a positive tilt with respect to a plane orthogonal to the optical axis of the chief ray 73 and have a positive tilt also with respect to the first surface 58aA. Further, the third surface 58c, which is a reflection surface at a third time and the first surface 58aC, which is a reflection surface at a fourth time, have a negative tilt with respect to a plane orthogonal to the optical axis of the chief ray 73 and have a negative tilt also with respect to the first surface 58aA.

The reflected tracking light 48 is, in a process of light reception by the tracking light receiving element 54, reflected sequentially by the second surface 58b, the first surface 58a, the third surface 58c, the first surface 58a and is transmitted through the dichroic film 46. That is, the reflected tracking light 48 goes through a reflection surface or a transmission surface five times in the light receiving prism 44. Further, as for the reflected tracking light 48, phase differences are added up at each incidence into each of the reflection surfaces and transmission surfaces, and the tracking image 72 having a total phase difference is formed on the tracking light receiving element 54.

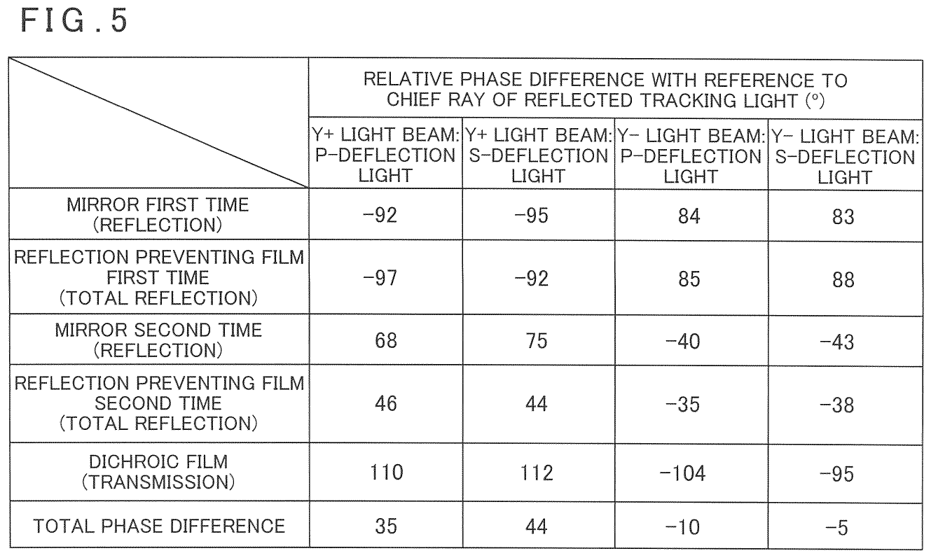

FIG. 5 illustrates a relative phase difference with reference to the chief ray 73, when a p-deflection light and an s-deflection light of the Y+ light beam 74 and a p-deflection light and an s-deflection light of the Y− light beam 75 are incident into each of the reflection surfaces and transmission surfaces of the light receiving prism 44 and a total phase difference (angular change of a phase) acquired by adding up the phase differences on each of the reflection surfaces and the transmission surfaces.

It is to be noted that, in FIG. 5, a mirror first time indicates a reflection at the second surface 58b, which is a reflection at a first time, and a mirror second time indicates a reflection at the third surface 58c, which is a reflection at a third time. Since the second surface 58b and the third surface 58c are both applied with the mirror finishing, the second surface 58b and the third surface 58c become reflection surfaces with a same or similar film quality. Further, a reflection preventing film first time indicates a total reflection at the first surface 58a, which is a reflection at a second time, and a reflection preventing film second time indicates a total reflection at the first surface 58a, which is a reflection at a fourth time. Since the reflection second time and the reflection fourth time are both reflection at the first surface 58a, the second time and the fourth time are reflection surfaces with the same or similar film quality.

As shown in FIG. 5, in the reflection surface, when an incident angle is larger than an incident angle of the chief ray 73, a p-deflection light and an s-deflection light generate a negative phase difference with respect to the chief ray 73, respectively. Further, when an incident angle is smaller than an incident angle of the chief ray 73, the p-deflection light and the s-deflection light generate a positive phase difference with respect to the chief ray 73, respectively. On the other hand, in the transmission surface, when an incident angle is larger than an incident angle of the chief ray 73, the p-deflection light and the s-deflection light generate a positive phase difference with respect to the chief ray 73, respectively. Further, when an incident angle is smaller than an incident angle of the chief ray 73, the p-deflection light and the s-deflection light generate a negative phase difference with respect to the chief ray 73, respectively.

For instance, in the second surface 58b, which is a reflection surface having a positive tilt with respect to a plane orthogonal to an optical axis of the chief ray 73, the Y+ light beam 74 generates a negative phase difference with respect to the chief ray 73, and the Y− light beam 75 generates a positive phase difference with respect to the chief ray 73. Further, in the third surface 58c, which is a reflection surface having a negative tilt with respect to a plane orthogonal to an optical axis of the chief ray 73, the Y+ light beam 74 generates a positive phase difference with respect to the chief ray 73, and the Y− light beam 75 generates a negative phase difference with respect to the chief ray 73.

On the other hand, in the dichroic film 46, which is a transmission surface having a positive tilt with respect to a plane orthogonal to an optical axis of the chief ray 73, the Y+ light beam 74 generates a positive phase difference with respect to the chief ray 73, and the Y− light beam 75 generates a negative phase difference with respect to the chief ray 73.

Further, by means of a size of an incident angle with reference to an incident angle of the chief ray 73 and a film quality of a reflection surface or a transmission surface, a phase difference changes. The light receiving prism 44 has two pairs of reflection surfaces. Each pair of the reflection surfaces has two reflection surfaces which constitute by the same film quality and different positive/negative tilts.

As described above, depending on which of a positive tilt and a negative tilt with respect to the first surface 58a (a plane orthogonal to an optical axis of the chief ray 73) into which the chief ray 73 is incident at an incident angle of 0°, the reflection surface and the transmission surface have, the reflected tracking light 48 generates a positive phase difference or a negative phase difference with respect to the chief ray 73. That is, between a phase difference generated when a reflection surface or a transmission surface has a positive tilt with respect to the first surface 58a and a phase difference generated when a reflection surface or a transmission surface has a negative tilt with respect to the first surface 58a, positive/negative become opposite to each other. Therefore, by providing at least one each of a reflection surface and a transmission surface having positive and negative tilts, it is possible to offset a phase difference with reference to the chief ray 73 generated in the reflected tracking light 48.

Here, total phase differences (angular change of a phase) in p-deflections of the chief ray 73, the Y+ light beam 74, the Y− light beam 75 are assumed to be δp0, δp+, δp− and a total phase difference in s-deflections of the chief ray 73, the Y+ light beam 74, the Y− light beam 75 are assumed to be δs0, δs+, δs−, respectively. In this case, when δp0, δp+, δp−, δs0, δs+, δs− satisfy the following two equations, that is, they are within a predetermined threshold value range, it is known that an interference fringe does not occur in the tracking image 72.

$$Δ p = max [ δ p 0 , δ p + , δ p - \} - min [ δ p 0 , δ p + , δ p - \} <= 180 ° \qquad ( equation 1 )$$

$$Δ s = max [ δ s 0 , δ s + , δs - \} - min [ δ s 0 , δ s + , δ s - \} <= 180 ° \qquad ( equation 2 )$$

In the light receiving prism 44, it is Δp=max {δp0, bp+, δp−}−min {δp0, δp+, δp−}<=45°, and Δs=max {δs0, δs+, δs−}−min {δs0, δs+, δs−}<=49° and thus, it is within a predetermined threshold value range, that is, within 180°, and both (equation 1) and (equation 2) are satisfied.

Therefore, even when the reflected tracking light 48 is internally reflected a plurality of number of times in the light receiving prism 44, and is transmitted through the dichroic film 46, it is possible to acquire the tracking image 72 without an interference fringe.

As described above, in the first embodiment, the light receiving prism 44 is constituted by three prisms, that is, the first prism 58, the second prism 59, and the third prism 60 and by means of the first prism 58 and the second prism 59, the recess portion 63 recessed toward the first surface 58a is formed on a surface on a side opposite to the incident surface (the first surface 58a) of the reflected distance measuring light 47 and the reflected tracking light 48.

Further, the light receiving fiber 39, which is a light receiver, is provided in the recess portion 63 and is extended upward along the second surface 58b and further, the light receiving fiber 39 is bent toward the first surface 58a side such that it passes through a depth side of the light receiving prism 44.

Therefore, regardless of a bending radius of the light receiving fiber 39, the light receiving fiber 39 does not protrude from the light receiving prism 44 to a side opposite to the incident surface and thus, it is possible to reduce a length of the light receiving optical system 49 in a direction of the light receiving optical axis 41 (left-right direction with respect to a paper surface in FIG. 2) reflected by the scanning mirror 15, and it is possible to reduce the sizes of the light receiving optical system 49 and the surveying instrument 1.

Further, the second surface 58b is parallel or substantially parallel to the light receiving optical axis 41 reflected by the dichroic film 46, and the light receiving fiber 39 also extends upward in parallel or substantially parallel to the second surface 58b. Therefore, the light receiving fiber 39 is not brought into contact with the light receiving prism 44 or does not protrude to a side opposite to the incident surface of the reflected distance measuring light 47 and the reflected tracking light 48 from the recess portion 63, either, and it is possible to reduce the size of the light receiving optical system 49. Further, since it is possible to dispose the second chamfered portion 62, the light receiving fiber 39, a right end of the sensor substrate 66 within substantially the same plane, it is possible to further reduce the size of the light receiving optical system 49.

Further, in the light receiving prism 44, a tilt with respect to a plane (the first surface 58a) orthogonal to an optical axis of the chief ray 73 of the reflected tracking light 48 is adjusted, and at least each one of a surface having a positive tilt and a surface having a negative tilt with respect to the plane are provided and thus, it is possible to offset a phase difference of the reflected tracking light 48 generated at a reflection or a transmission.

Therefore, it is possible to reduce a phase difference generated in the reflected tracking light 48 to such a range that an interference fringe does not occur, and it is possible to acquire the tracking image 72 without an interference fringe and thus, it is possible to improve a calculation accuracy of a center of gravity of the tracking image 72 and to improve a tracking accuracy.

Further, in each of the reflection surface and the transmission surfaces in the light receiving prism 44, at least in one each of a surface having a positive tilt and a surface having a negative tilt with respect to a plane orthogonal to the chief ray 73, a film quality of the reflection surface and the transmission surface is the same or similar and thus, it is possible to reduce an adjustment difficulty of a total phase difference.

Further, it is configured such that the reflected distance measuring light 47 and the reflected tracking light 48 are internally reflected a plurality of number of times within the same plane by the light receiving prism 44 and then, the reflected distance measuring light 47 and the reflected tracking light 48 are received by the light receiving fiber 39 and the tracking light receiving element 54. Therefore, it is possible to make an optical path length in the light receiving optical axis 41 direction (left-right direction with respect to a paper surface) shorter, to reduce a size of the distance measuring module 19, and to reduce a weight of the surveying instrument 1.

Further, a chamfering is applied to a corner part of the light receiving prism 44 located outside optical paths of the reflected distance measuring light 47 and the reflected tracking light 48, and the first chamfered portion 61 and the second chamfered portion 62 are formed. Further, on the third surface 60c of the third prism 60, the band pass filter 64 with an equal or substantially equal size to a light flux diameter of the reflected tracking light 48 is provided, and on a part where the band pass filter 64 of the third surface 60c is not provided, that is, outside the optical path of the reflected tracking light 48, a reflection preventing paint is coated.

Therefore, it is possible to shut down a stray light passing through an inside of the light receiving prism 44 by the first chamfered portion 61, the second chamfered portion 62, the band pass filter 64 and thus, by receiving of the stray light with respect to the light receiving fiber 39 and the tracking light receiving element 54 is prevented, a deterioration of a distance measuring accuracy and a tracking accuracy can be prevented.

It is to be noted that, in the first embodiment, the light receiving prism 44 is configured to cause the reflected tracking light 48 reflected four times and transmitted once and has two each of reflection surfaces having a positive or a negative tilt with respect to a plane orthogonal to the chief ray 73. Further, in the first embodiment, two pairs of reflection surfaces with the same film quality and different tilt directions are provided.

On the other hand, the light receiving prism 44 only needs to have at least one each of reflection surfaces having positive and negative tilts with respect to a plane orthogonal to the chief ray 73. For instance, there may be one each of reflection surfaces having positive and negative tilts with respect to a plane orthogonal to the chief ray 73. Alternatively, there may be one reflection surface with a positive tilt and two or more reflection surfaces with a negative tilt with respect to a plane orthogonal to the chief ray 73 or there may be two or more reflection surfaces with a positive tilt and one reflection surface with a negative tilt with respect to a plane orthogonal to the chief ray 73. Further, the film quality of the reflection surface or the transmission surface does not necessarily have to be the same or similar.

That is, even other light receiving prism than the light receiving prism 44, when a total phase difference added up in a process in which the reflected tracking light 48 is sequentially reflected by or transmitted through a reflection surface or a transmission surface is within a predetermined threshold value range, it is possible to employ the light receiving prism to the light receiving optical system 49 of the present embodiment.

Further, a film for suppressing a phase difference may be separately deposited to a reflection surface or a transmission surface of the light receiving prism 44. By means of the deposition of the film, it is possible to further reduce the phase difference of the reflected tracking light 48, and it is possible to further improve a tracking accuracy.

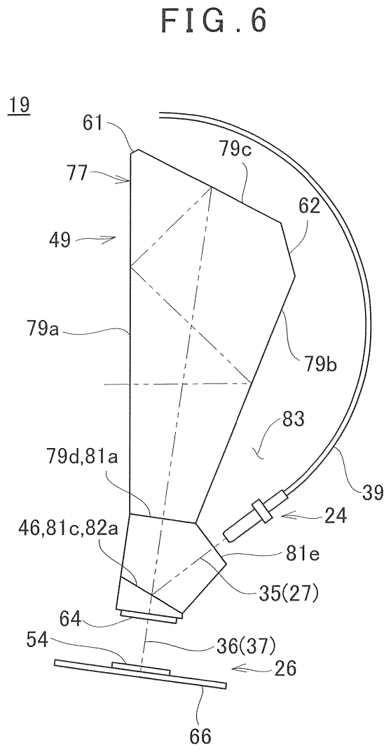

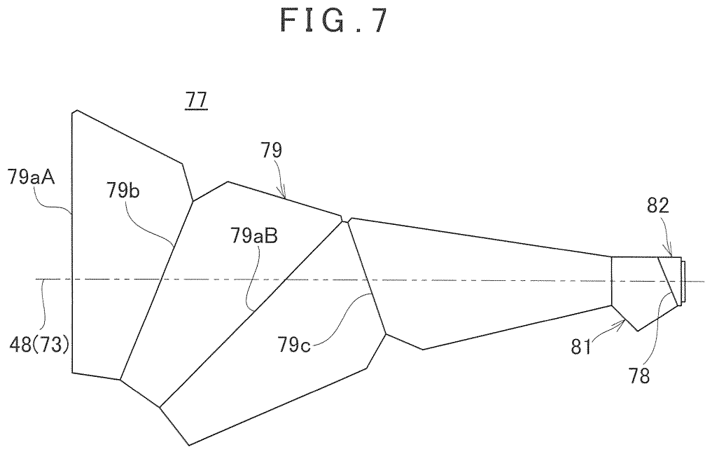

Next, in FIG. 6 and FIG. 7, a description will be given on a second embodiment of the present invention. It is to be noted that, in FIG. 6 and FIG. 7, the same components as shown in FIG. 2 and FIG. 4 are referred by the same symbols, and a description thereof will be omitted.

A light receiving prism 77 in the second embodiment has a first prism 79. Further, the light receiving prism 77 causes a reflected distance measuring light 47 and a reflected tracking light 48 incident into a first surface 79a of the first prism 79 at an incident angle 0° to be reflected by a second surface 79b, the first surface 79a, a third surface 79c sequentially in the same plane and then, to be incident into a first surface 81a of a second prism 81 joined to the first prism 79 via a fourth surface 79d.

That is, the light receiving prism 77 causes the reflected distance measuring light 47 and the reflected tracking light 48 to be internally reflected three times in the first prism 79 and causes the reflected distance measuring light 47 and the reflected tracking light 48 to be incident into the second prism 81. After that, it is configured such that the light receiving prism 77 causes the reflected distance measuring light 47 to be incident into the dichroic film 46 provided on a third surface 81c and a first surface 82a, which are joined surfaces of the second prism 81 and a third prism 82. The reflected distance measuring light 47 is reflected by a dichroic film 78 as a separation surface and is received by a light receiving fiber 39. Further, the reflected tracking light 48 is transmitted through the dichroic film 78, the third prism 82, the band pass filter 64 and is received by the tracking light receiving element 54.

It is to be noted that, similarly to the first embodiment, a reflection preventing film (AR coat) is provided across the whole surface of the first surface 79a, and the second surface 79b and the third surface 79c are mirrors to which the mirror finishing was applied to the whole surfaces.

In the second embodiment, too, on a surface on a side opposite to an incident surface (the first surface 79a) of the reflected distance measuring light 47 and the reflected tracking light 48, the first prism 79 has a surface (the second surface 79b) tilted upward from below in a direction separated from the incident surface with a joined surface with the second prism 81 as a starting point and the second prism 81 has a surface (fifth surface 81e) tilted downward from above in a direction separated from the incident surface with a joined surface with the first prism 79 as a starting point.

Therefore, by means of the second surface 79b and the fifth surface 81e, a recess portion 83 recessed to a side of the first surface 79a is formed on the light receiving prism 77.

Further, in the second embodiment, too, similarly to the first embodiment, a light receiving surface of the light receiving fiber 39 is disposed in the recess portion 83, and the light receiving fiber 39 extends upward and is bent to the first surface 79a side. On the other hand, in the second embodiment, the light receiving optical axis 41 reflected by the dichroic film 78 is not parallel to the second surface 79b, but the light receiving optical axis 41 is tilted in a direction separated from the second surface 79b.

However, since a part protruding the most of the light receiving fiber 39 is located diagonally above the light receiving prism 77, a protrusion amount to an opposite side from the light receiving prism 77 with respect to the first surface 79a becomes smaller than a bending radius of the light receiving fiber 39. Therefore, it is possible to reduce a size in a light receiving optical axis 41 direction of the light receiving optical system 49 (size in a horizontal direction), and it is possible to promote a size reduction of the distance measuring module 19 and the surveying instrument 1.

As shown in FIG. 7, the light receiving prism 77 has the second surface 79b and a first surface 79aB, which are reflection surfaces having a positive tilt with respect to a plane (first surface 79aA) orthogonal to an optical axis of the chief ray 73 of the reflected distance measuring light 47 and the third surface 79c, which is a reflection surface having a negative tilt with respect to a plane orthogonal to an optical axis of the chief ray 73.

In the second embodiment, too, the light receiving prism 77 has at least one each of a reflection surface having a positive tilt and a reflection surface having a negative tilt with respect to a plane orthogonal to an optical axis of the chief ray 73. Therefore, a negative phase difference generated at a reflection of the reflected tracking light 48 at the second surface 79b and the first surface 79aB is offset by a positive phase difference generated at a reflection by the third surface 79c, and it is possible to reduce a total phase difference (angular change of a phase) to equal to or smaller than a predetermined threshold value and thus, it is possible to acquire the tracking image 72 without an interference fringe (see FIG. 3B) and to improve a tracking accuracy.

Further, the second surface 79b having a positive tilt and the third surface 79c having a negative tilt with respect to a plane orthogonal to an optical axis of the chief ray 73 are both mirrors to which a mirror finishing was applied. That is, since the second surface 79b and the third surface 79c are reflection surfaces of the same or similar film specification having opposing tilts, it is possible to reduce an adjustment difficulty of a total phase difference.

### LEGEND OF REFERENCE NUMERALS

1 Surveying instrument
15 Scanning mirror
17 Arithmetic control module
19 Distance measuring module
23 Distance measuring light projecting module
24 Distance measuring light receiving module
Tracking light projecting module
26 Tracking light receiving module
Distance measuring light
36 Tracking light
39 Light receiving fiber
44 Light receiving prism
46 Dichroic film
47 Reflected distance measuring light
48 Reflected tracking light
63 Recess portion
77 Light receiving prism
78 Dichroic film
83 Recess portion

1. A surveying instrument comprising: a distance measuring light projecting module having a light emitter which emits a distance measuring light to an object, a distance measuring light receiving module having a light receiver which receives a reflected distance measuring light from said object, and an arithmetic control module which controls said distance measuring light projecting module and calculates a distance to said object based on a light receiving result of said reflected distance measuring light with respect to said light receiver, wherein said distance measuring light receiving module has a light receiving prism which causes said reflected distance measuring light to be internally reflected at least once in a same plane, said light receiving prism is configured such that, on a surface on a side opposite to an incident surface of said reflected distance measuring light, a recess portion recessed to said incident surface side is formed, and said light receiver is arranged in said recess portion.

2. The surveying instrument according to claim 1, wherein said light receiver is a light receiving fiber, and said light receiving fiber is configured to extend upward and bend toward said incident surface.

3. The surveying instrument according to claim 2, wherein an optical axis of said reflected distance measuring light received by said light receiving fiber is configured to become parallel or substantially parallel to a surface on a side opposite to an incident surface of said reflected distance measuring light.

4. The surveying instrument according to claim 1, wherein said light receiving prism is constituted by a first prism, a second prism joined to said first prism, and a third prism joined to said second prism, said recess portion is formed by said first prism and said second prism, and said reflected distance measuring light is configured to be reflected toward said recess portion by a separation surface formed on a joined surface between said second prism and said third prism.

5. The surveying instrument according to claim 4, further comprising: a tracking light projecting module having a tracking light emitter which emits a tracking light coaxially with said distance measuring light to said object and a tracking light receiving module which receives a reflected tracking light from said object coaxially with said reflected distance measuring light, wherein said tracking light receiving module has a tracking light receiving element provided on a sensor substrate disposed on a transmission side of said separation surface, said light receiving prism is configured to separate said reflected distance measuring light and said reflected tracking light which are coaxially incident by said separation surface and cause said reflected tracking light to be received by said tracking light receiving element.

6. The surveying instrument according to claim 5, wherein a chamfering is applied to a corner part of said first prism, a chamfered portion is formed, and a reflection preventing paint is coated to said chamfered portion.

7. The surveying instrument according to claim 6, wherein a band pass filter having a same diameter or a substantially same diameter as that of a light flux of said reflected tracking light is provided on a projection surface of said reflected tracking light of said light receiving prism, and a reflection preventing paint is coated to spots other than said band pass filter of said projection surface.

8. The surveying instrument according to claim 7, wherein said chamfered portion, said light receiver, and an end part on a side opposite to said incident surface of said sensor substrate are configured to be disposed on a substantially same plane.
